(19) United States
(12) Patent Application Publication
(10) Pub. No.: US 2010/0107364 A1
(43) Pub. Date: May 6, 2010

(54) HINGE AND COLLAPSIBLE DEVICE UTILIZING THE SAME

(75) Inventor: Wen-Bin Shen, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/331,411

(22) Filed: Dec. 9, 2008

(30) Foreign Application Priority Data
Nov. 6, 2008 (CN) 200820302673.2

(51) Int. Cl. E05D 3/00

(52) U.S. Cl. 16/221

(57) ABSTRACT

A hinge includes a first connecting member, a second connecting member, a shaft fixed to the first connecting member, and a fastening member. The second connecting member includes a sleeve axially defining an opening in a circumference of the sleeve. A first fixing board and a second fixing board opposite to the first fixing board both perpendicularly extend from the circumference of the sleeve, and locate at opposite sides of the opening. The shaft is rotated relative to the second connecting member, with the first connecting member, and includes a fixing rod rotatably received in the sleeve. The fastening member is capable of adjustably tightening the first and second fixing boards to squeeze or expand the sleeve, and then, the sleeve is forced to adjustably clamp the fixing rod.

### BACKGROUND

1. Technical Field

The present disclosure relates to hinges and, particularly, to a hinge and a collapsible device utilizing the same.

2. Description of Related Art

A collapsible device, such as a notebook computer, or a clamshell mobile phone, generally including a main body and a display, often uses a hinge to interconnect the main body and the display. The hinge includes a female hinge member mounted to the cover and a male hinge member mounted to the base, thereby allowing the display to be rotational with respect to the main body, and to be folded to the main body for saving space.

The male hinge member includes a split shaft sleeve, and the female hinge member includes a shaft rotatably received in the shaft sleeve. The shaft is in frictional engagement with an inner wall of the shaft sleeve during rotation of the shaft relative to the shaft sleeve. Therefore, the display can maintain at any angle with respect to the main body by friction between the shaft and the shaft sleeve. However, this kind of hinges is not durable because the shaft and the shaft sleeve are easily worn out. Even worse, after frequent usage and due to wear and tear, the shaft and the shaft sleeve could no longer fit together tightly, thereby preventing the display from being able to stay at certain desirable positions. As a result, the display cannot maintain stability at almost any angle with respect to the main body, which creates inconvenience for users.

### BRIEF DESCRIPTION OF THE DRAWINGS

FIG. 1 is an exploded, isometric view of an exemplary embodiment of a hinge.

FIG. 2 is an assembled, isometric view of the hinge of FIG. 1.

FIG. 3 is similar to FIG. 2, but viewed from another perspective.

FIG. 4 is an isometric view of an exemplary embodiment of a collapsible device utilizing the hinge of FIG. 1.

### DETAILED DESCRIPTION

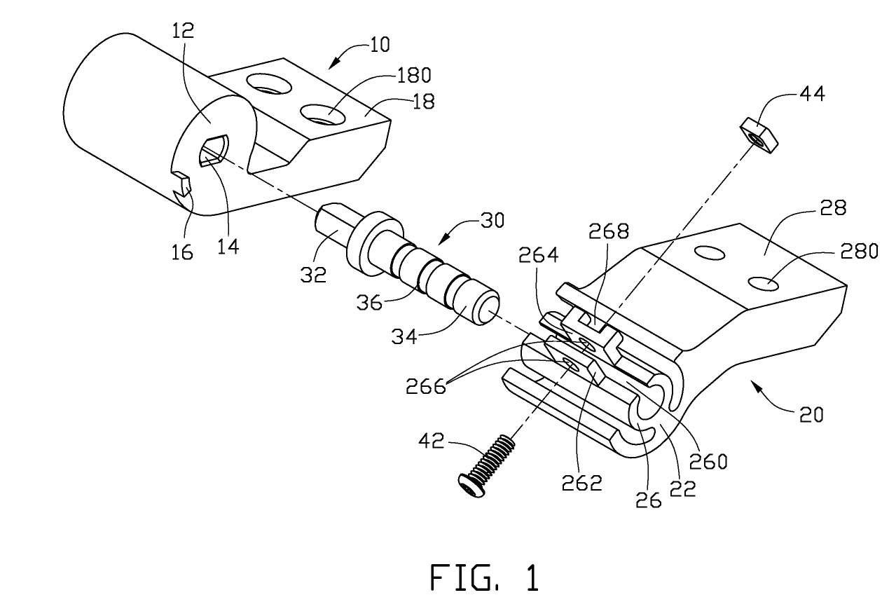

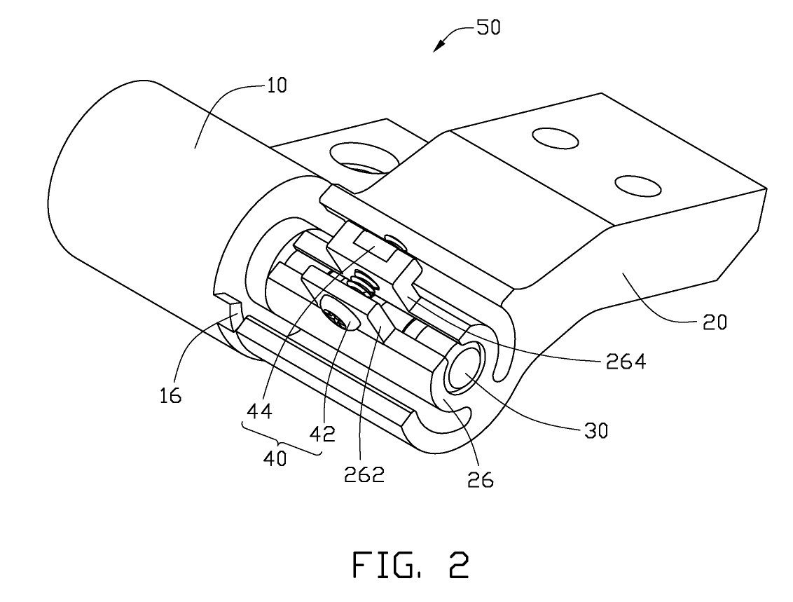

Referring to FIGS. 1 and 2, an exemplary embodiment of a hinge 50 includes a first connecting member 10, a second connecting member 20, a shaft 30 mounted to the first and second connecting members 10 and 20, and a fastening member 40 for firmly clamping the second connecting member 20 and the shaft 30.

The first connecting member 10 includes a flat connecting portion 18 defining a plurality of fixing holes 180, and a cylindrical fixing portion 12 positioned at a side of the connecting portion 18. The fixing portion 12 axially defines a fixing hole 14 in an end surface of the fixing portion 12. The fixing hole 14 has a double-D shape in the instant embodiment. A stop post 16 adjacent to the fixing hole 14 axially extends from a circumference of the fixing portion 12.

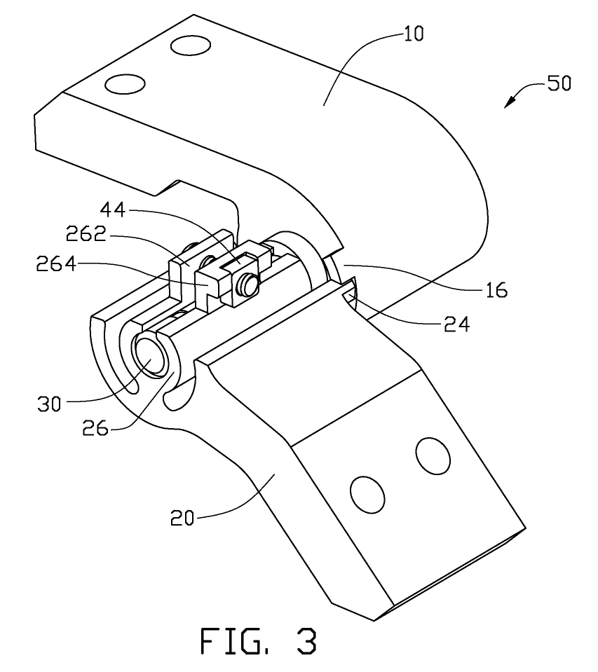

The second connecting member 20 includes a flat securing portion 28 defining a plurality of fixing holes 280, a receiving portion 22, and a sleeve 26. The receiving portion 22 having a generally C-shaped cross-section extends from an end of the securing portion 28. A stop block 24 (shown in FIG. 3) axially extends from an end of the receiving portion 22, adjacent to the securing portion 28. The sleeve 26, having a generally C-shaped cross-section, forms from an inner side of the receiving portion 22. The receiving portion 22 and the sleeve 26 are coaxial. An opening 260 is longitudinally defined, extending one end of the sleeve 26 to the opposite end of the sleeve 26, to enable deformation of the sleeve 26. A first fixing board 262 and a second fixing board 264 opposite to the first fixing board 262 perpendicularly extend from the sleeve 26 and located at opposite sides of the opening 260. Each of the first and second fixing boards 262 and 264 defines a through hole 266. The second fixing board 264 defines a receiving space 268 opposite to the first fixing board 262 and communicating with the fixing hole 266 of the second fixing board 264. Obviously, in other embodiments, the first fixing board 262 can define a receiving space 268 communicating with the fixing hole 266 of the first fixing board 262.

The shaft 30 includes a fixing portion 32 having a double-D shaped cross-section in the instant embodiment, a cylindrical-shaped fixing rod 34 opposite to the fixing portion 32, and a flange protrusion (not labeled) between the fixing portion 32 and the fixing rod 34. A plurality of circular slots 36 capable of retaining lubricant are defined in a circumference of the fixing rod 34.

The fastening member 40 includes a screw 42 and a matching screw nut 44. In the instant embodiment, the screw nut 44 is square-shaped.

Referring to FIGS. 2 and 3, in assembly, the fixing portion 32 of the shaft 30 is fixed in the fixing hole 14 of the first connecting member 10, with a side of the flange protrusion of the shaft 30 resisting against the fixing portion 12. Therefore, the shaft 30 is unrotatably fixed to the first connecting member 10. The fixing rod 34 is rotatably passed through the sleeve 26. The screw nut 44 is received in the receiving space 268. The screw 42 is adjustably passed through the fixing holes 266 of the first and second fixing boards 262 and 264 in turn, and then, screwed into the screw nut 44. Therefore, the sleeve 26 is adjustable to make the sleeve 26 clamp the fixing rod 34.

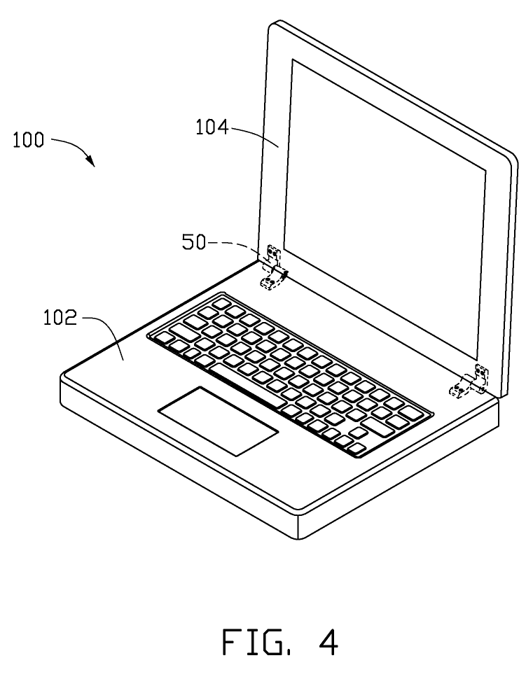

Referring to FIG. 4, in use, the above-mentioned hinge 50 is utilized in a collapsible device 100, here for instance, in a notebook computer that includes a base 102 and a cover 104. The fixing holes 180 are configured for allowing fastening members, such as screws, bolts, or rivets, etc., to extend through, thereby fixing the first connecting member 10 to one of the cover 104 and the base 102. Similarly, the fixing holes 280 are configured for allowing fastening members, such as screws, bolts, or rivets, etc., to extend through, thereby the second connecting member 20 is fixed to the other one of the cover 104 and the base 102. Therefore, during rotation of the cover 104 or the base 102, the first connecting member 10 rotates relative to the second connecting member 20, with the fixing rod 34 rotatable relative to the sleeve 26. As a result, friction between the fixing rod 34 and the sleeve 26 positions the cover 104 maintaining stability at any angle with respect to the base 102. The stop post 16 can resist against the stop block 24 during the rotation of the base 102 relative to the cover 14, to limit the rotation range of the shaft.

After frequent usage and due to wear and tear, the sleeve 26 and the fixing rod 34 may no longer abut tightly against each other, resulting in reduce friction, so that the cover 104 cannot be maintained at any angle with respect to the base 102. Therefore, the screw 42 can be tightened urging the first and second fixing boards 262 and 264 closer together, resulting in squeezing the sleeve 26 to firmly clamp the fixing rod 34 again.

It is believed that the present embodiments and their advantages will be understood from the foregoing description, and it will be apparent that various changes may be made thereto without departing from the spirit and scope of the description or sacrificing all of its material advantages, the examples hereinbefore described merely being exemplary embodiments.

What is claimed is:

1. A hinge comprising:
a first connecting member;
a second connecting member comprising a sleeve axially defining an opening in a circumference of the sleeve, a first fixing board and a second fixing board opposite to the first fixing board extending from the circumference of the sleeve and located at opposite sides of the opening, respectively;
a shaft fixed to the first connecting member, and comprising a fixing rod rotatably received in the sleeve; and
a fastening member for adjustably tightening the first and second fixing boards to squeeze or expand the sleeve.

2. The hinge of claim 1, wherein each of the first and second fixing boards defines a fixing hole; the fastening member comprises a screw and a matching screw nut; the screw nut is engaged with the screw after the screw is passed through the fixing holes of the first and second fixing boards.

3. The hinge of claim 2, wherein the second fixing board defines a receiving space opposite to the first fixing board and communicating with the fixing hole of the second fixing board, for receiving the screw nut.

4. The hinge of claim 2, wherein the screw nut is square-shaped.

5. The hinge of claim 1, wherein the first connecting member comprises a stop post extending from the first connecting member; the second connecting member comprises a stop block extending from the second connecting member; the stop post is capable of resisting against the stop block to limit the rotation range of the shaft.

6. The hinge of claim 5, wherein the first connecting member comprises a fixing portion defining a fixing hole therein for fixing the shaft; the stop post extends from a circumference of the fixing portion, and is adjacent to the fixing hole.

7. The hinge of claim 5, wherein the second connecting member comprises a receiving portion for receiving the sleeve; the stop block extends from a circumference of the receiving portion.

8. The hinge of claim 7, wherein the receiving portion has a general C-shaped cross-section; the sleeve axially extends from an inner side of the receiving portion.

9. A collapsible device comprising:
a base;
a hinge comprising:
a first connecting member comprising a connecting portion;
a second connecting member comprising a securing member and a sleeve extending from the securing member, the sleeve axially defining an opening in a circumference of the sleeve, a first fixing board and a second fixing board opposite to the first fixing board extending from the circumference of the sleeve and located at opposite sides of the opening, respectively;
a shaft fixed to the first connecting member, and comprising a fixing rod rotatably received in the sleeve; and
a fastening member for adjustably tightening the first and second fixing boards; and
a cover pivotally mounted to the base via the hinge;
wherein the connecting portion is fixed to one of the cover and the base, and the securing portion is fixed to the other one of the cover and the base; the shaft is capable of rotating relative to the second connecting member, together with the first connecting member; the sleeve is capable of being squeezed to tightly clamp the fixing rod in response to the fastening member tightening the first and second fixing boards.

10. The collapsible device of claim 9, wherein each of the first and second fixing boards defines a fixing hole; the fastening member comprises a screw and a matching screw nut; the screw nut is engaged with the screw after the screw is passed through the fixing holes of the first and second fixing boards.

11. The collapsible device of claim 10, wherein the second fixing board defines a receiving space opposite to the first fixing board and communicating with the fixing hole of the second fixing board, for receiving the screw nut.

12. The collapsible device of claim 10, wherein the screw nut is square-shaped.

13. The collapsible device of claim 9, wherein the first connecting member comprises a stop post extending from the first connecting member; the second connecting member comprises a stop block extending from the second connecting member; the stop post is capable of resisting against the stop block to limit the rotation range of the shaft.

14. The collapsible device of claim 13, wherein the first connecting member further comprises a fixing portion extending from the connecting member, the fixing portion defines a fixing hole for fixing the shaft; the stop post extends from a circumference of the fixing portion, and is adjacent to the fixing hole.

15. The collapsible device of claim 13, wherein the second connecting member further comprises a receiving portion for receiving the sleeve; the stop block extends from a circumference of the receiving portion.

16. The collapsible device of claim 15, wherein the receiving portion has a general C-shaped cross-section; the sleeve axially extends from an inner side of the receiving portion.
